(19) United States
(12) Patent Application Publication
(10) Pub. No.: US 2026/0150986 A1
(43) Pub. Date: Jun. 4, 2026

(54) FRAMELESS SUSPENSION DEVICE

(71) Applicant: Dawn M. Beachy, Annapolis, MD (US)

(72) Inventor: Dawn M. Beachy, Annapolis, MD (US)

(21) Appl. No.: 19/408,085

(22) Filed: Dec. 3, 2025

Related U.S. Application Data
(60) Provisional application No. 63/727,615, filed on Dec. 3, 2024.

(51) Int. Cl. A47G 1/16; F16M 13/02

(52) U.S. Cl. CPC A47G 1/1626; F16M 13/022

(57) ABSTRACT

A hanging box is disclosed for suspending a displayable item, such as a metal picture, on a wall without the need for a frame. The box is configured to receive the rear surface of the displayable item and has a thickness of approximately ½-¾ of an inch, thereby spacing the picture uniformly from the wall to create a floating appearance. An opening approximately 1.5 inches wide and ¾ inch high is formed in the box, with spaced teeth configured to engage a conventional picture hanger hook. Plastic bumpers are disposed at the corners of the box to contact the wall surface, preventing scratches and maintaining stability. In some implementations, the box is constructed of aluminum. The apparatus provides a durable, protective suspension system for frameless display of metal pictures, photographs, or artwork.

### CROSS-REFERENCE TO RELATED APPLICATIONS

This application claims priority from U.S. provisional application 63/727,615 filed Dec. 3, 2024, the entire contents of which are incorporated by reference herein.

### BACKGROUND

### Technical Field

The present disclosure relates to wall-mounting devices, and more particularly to a suspension system enabling frameless display of items on walls.

### Description of the Related Art

Traditional picture frames provide both aesthetic and functional support for artwork, but they add bulk, cost, and complexity. Frameless mounting systems exist, yet many fail to provide consistent spacing from the wall or adequate protection for the wall surface. Either framing mounts behind the photo or heavy blocks are arranged behind a metal sheet to allow hanging. Some print labs do have a box attachment for metal pictures but the hanging hole doesn't provide adequate space for wall picture hanger hooks.

There remains a need for a durable, integrated suspension apparatus that allows pictures (including but not in any way limited to metal pictures), to be hung without frames, while ensuring secure engagement with standard picture hooks and preventing wall damage.

### SUMMARY

A frameless suspension device includes a hanging box affixed to the rear surface of a metal picture. The box has a thickness of approximately ½-¾ of an inch, thereby spacing the picture uniformly from the wall to create a floating appearance. An opening approximately 1.5 inches wide and ¾ of an inch high is formed in the box, with spaced teeth configured to engage a conventional picture hanger hook. Plastic bumpers are disposed at the corners of the box to contact the wall surface, preventing scratches and maintaining stability. The apparatus offers a durable, frameless suspension solution for metal pictures, photographs, artwork, or anything that a user would like to hang. In some implementations, the box may be constructed of aluminum.

In one implementation, an apparatus for suspending a displayable item on a wall, includes a box configured to receive a rear surface of the displayable item, the box having a thickness of approximately ½ to ¾ of an inch. An opening is formed in the box, the opening being about 1.5 inches wide and ¾ inch high. A plurality of spaced teeth are disposed within the opening and configured to engage with a hook, optional plastic bumpers may be disposed at corners of the box to contact the wall surface.

In another implementation, which may be combined with the first implementation, the box is constructed of aluminum.

In another implementation, which may be combined with one or more of the previous implementations, the box is constructed of a plastic.

In another implementation, which may be combined with one or more of the previous implementations, the box is rectangular and extends across at least a central portion of the rear surface of the displayable item.

In another implementation, which may be combined with one or more of the previous implementations, the teeth are angled to resist upward disengagement from the hook.

In another implementation, which may be combined with one or more of the previous implementations, the bumpers are formed of an elastomeric material.

In another implementation, which may be combined with one or more of the previous implementations, the aluminum box is anodized for corrosion resistance.

In another implementation, which may be combined with one or more of the previous implementations, wherein the displayable item is a picture.

In another implementation, which may be combined with one or more of the previous implementations, the display item is a metal picture.

In another implementation, which may be combined with one or more of the previous implementations, the bumpers maintain a uniform spacing between the picture and the wall surface.

In another implementation, which may be combined with one or more of the previous implementations, the hook is a picture hook.

In another implementation, which may be combined with one or more of the previous implementations, the box is configured to have the rear surface of the displayable item affixed thereto by adhesive, fasteners, or welding.

### BRIEF DESCRIPTION OF THE DRAWINGS

FIG. 1 is a perspective view of an aluminum hanging box attached to a metal picture.

FIG. 2 is another view showing an aluminum hanging box and corner bumpers.

FIG. 3 another view of the aluminum hanging box with slightly different dimensions.

FIG. 4 another view of the aluminum hanging box with slightly different dimensions.

FIG. 5 another view of the aluminum hanging box with slightly different dimensions.

FIG. 6 is a perspective view of the hanging box according to an illustrative implementation.

FIG. 7 is a view of an aluminum hanging box showing an adhesive for receiving a displayable item, according to an illustrative implementation.

FIG. 8A is a rear view of the aluminum hanging box showing the bumpers and the floating frame, according to an illustrative implementation.

FIG. 8B is a rear view of another implementation of the aluminum hanging box showing the bumpers and the floating frame.

### DETAILED DESCRIPTION

In the following description, numerous specific details are set forth to clearly describe various specific embodiments disclosed herein. One skilled in the art, however, will understand that the presently claimed disclosure may be practiced without all of the specific details discussed below. In other instances, well-known features have not been described so as not to obscure the novel aspects of the disclosure.

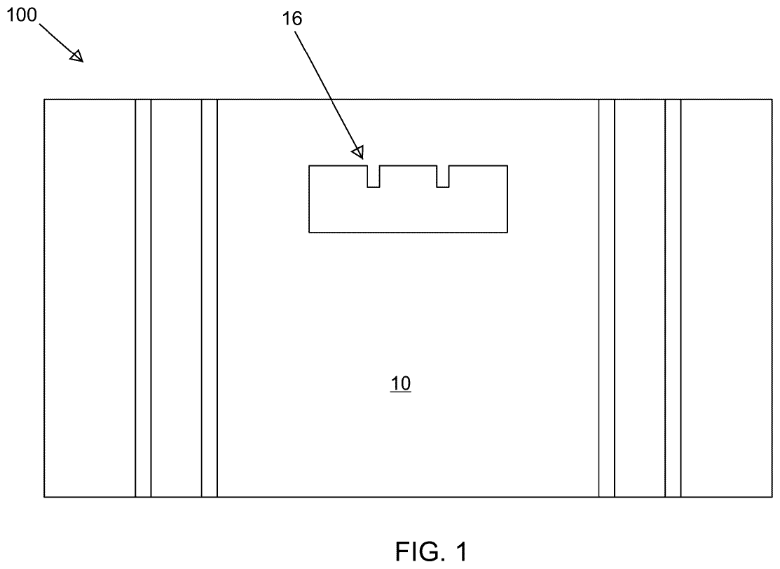

FIG. 1 shows a box 10 has a front surface that is configured to have a picture secured thereto by adhesive, fasteners, or welding. For example, the rear surface of a photo may be secured to the front surface of the box 10. In some implementations, the box 10 is rectangular and extends across a central portion of the rear surface of the picture. The box 10 has a thickness of approximately ½ to ¾ of an inch, thereby spacing the picture uniformly from the wall to create a floating effect. In some implementations, the box 10 may be known as an “EZ Metal Mount” apparatus.

An opening approximately 1.5 inches wide and ¾ inch high is formed in the box. Within the opening are spaced teeth 16 configured to engage a conventional picture hanger hook, or hanger wire. The teeth 16 may be angled or serrated to resist upward disengagement. The opening is dimensioned to accommodate standard wall hooks used in residential and commercial settings.

For example, standard wall hooks in residential and commercial settings typically range from 1-3 inches in projection (depth from wall) and 1-2 inches in width, with weight capacities from 5 lbs. for light picture hooks up to 50 lbs. for heavy-duty commercial hooks. In the case of commercial hooks, for example, in retail slotted wall standards, hooks typically fit ½-inch or 1-inch slots in wall standards. Lengths vary from 2 inches (small merchandise) to 12 inches (large items). In industrial heavy-duty hooks, a projection may be 3-6 inches, with a capacity of 50-100 lbs., depending on the anchor and wall material.

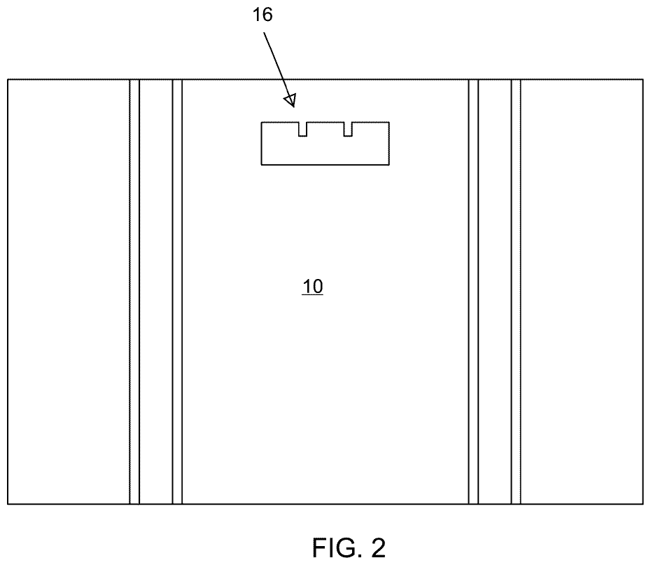

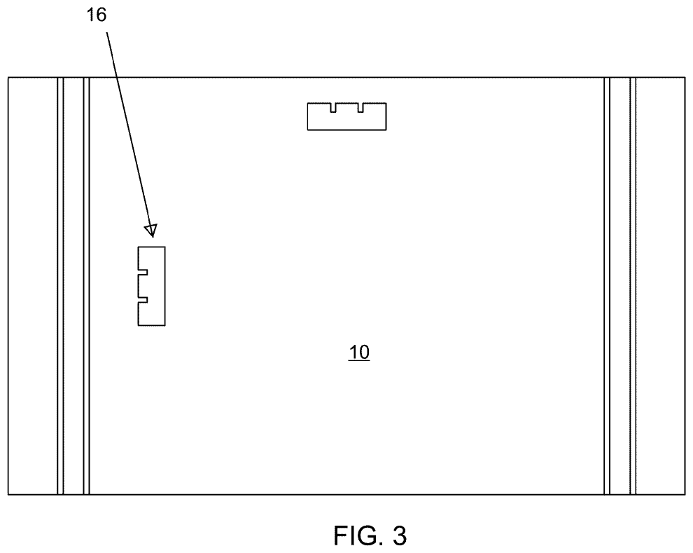

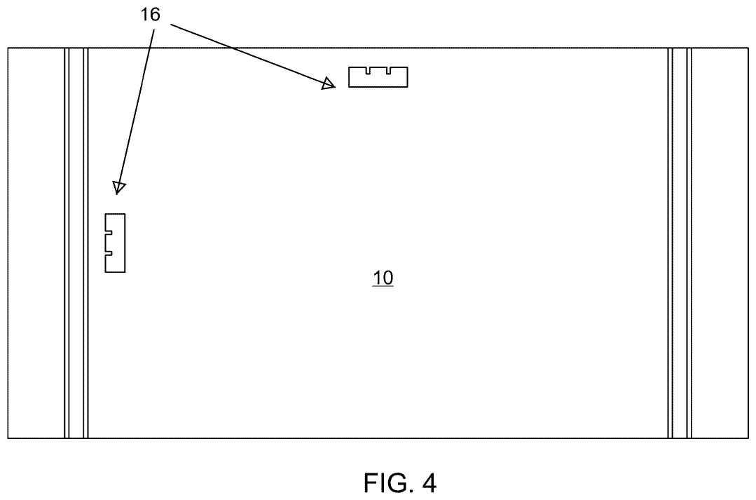

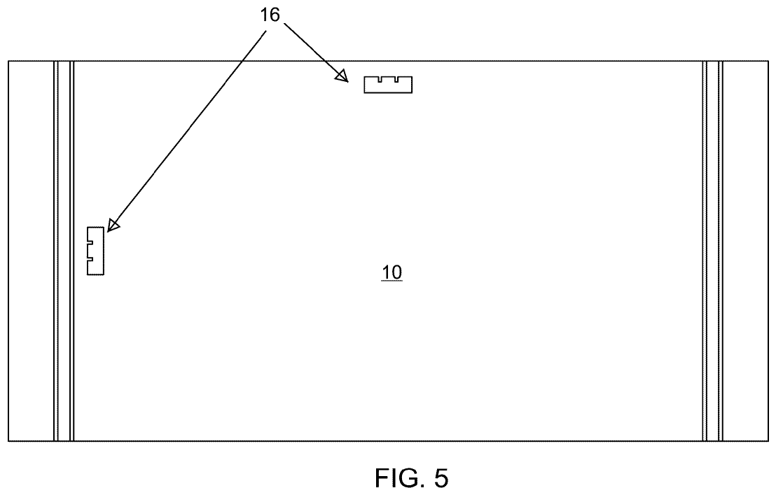

FIGS. 2, 3, 4 and 5 show various implementations of the hanging box. For example, FIG. 2 is a smaller set of teeth 16 arranged in a similar position as in FIG. 1. FIG. 3 has two sets of teeth at a substantially right angle, as does the hanging box in FIG. 4. FIG. 5 has somewhat smaller teeth 16 arranged at substantially right angles to each other.

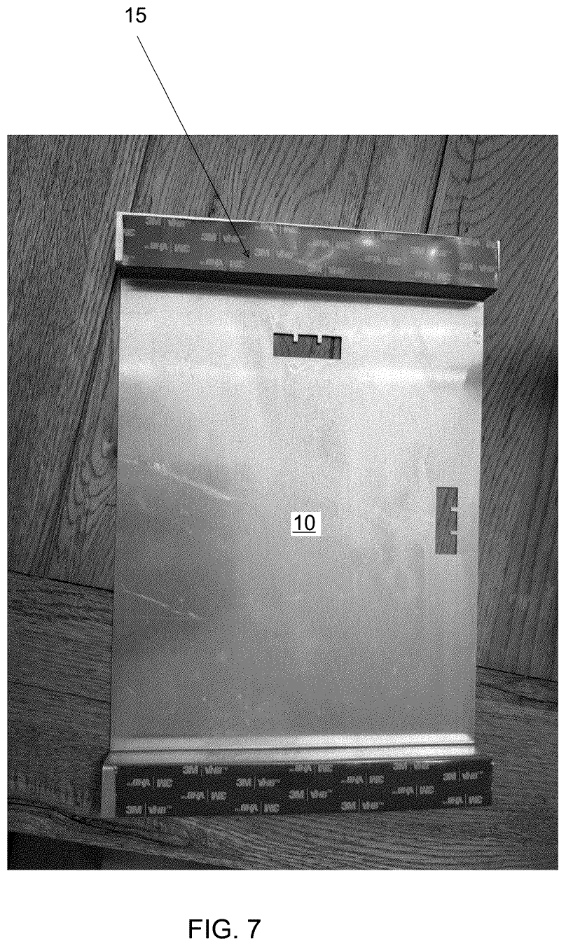

Plastic bumpers 20 (see FIG. 7) may be disposed at the corners of the box. The bumpers 20 are formed of an elastomeric material and project slightly beyond the rear surface of the box. When the picture is hung, the bumpers contact the wall surface, preventing scratches and stabilizing the picture. The bumpers also ensure that the spacing between the picture and wall remains uniform.

The aluminum box 10 may be anodized or coated for corrosion resistance. Alternative embodiments may vary the dimensions of the opening, the arrangement of teeth, or the material of the bumpers, while maintaining the essential features of floating offset, secure hook engagement, and wall protection.

The presently disclosed hanging box may be used by photographers, artists, print labs, anyone who has a metal picture, artwork, or anything that a user would like to hang, and desires to free hang it or hang it without a frame around the perimeter of the item. According to some implementations presently disclosed, the hanging box is a complete hanging apparatus installed on the back of any metal picture, artwork or anything that a user would like to hang.

According to some implementations, the presently disclosed hanging box apparatus includes an aluminum box 10 in a rectangular shape, ½″-¾″ thick with plastic bumpers on the corners of the rectangle. According to some implementation's embodiments, the box 10 may be made out of aluminum, wood, or plastic, and capable of suspending a metal picture artwork, or anything that a user would like to hang, frameless and ½″ away from the wall. According to some embodiments, the aluminum box may have an opening which is about 1.5″ wide and ¾″ high with spaced teeth such that a picture hanging hook can latch onto the hanging box. According to some embodiments, the presently disclosed aluminum hanging box 10 may be used to hang a displayable item such as a metal picture, artwork or anything that a user would like to hang, without a frame around the displayable item, and spaced ½″ away from the wall.

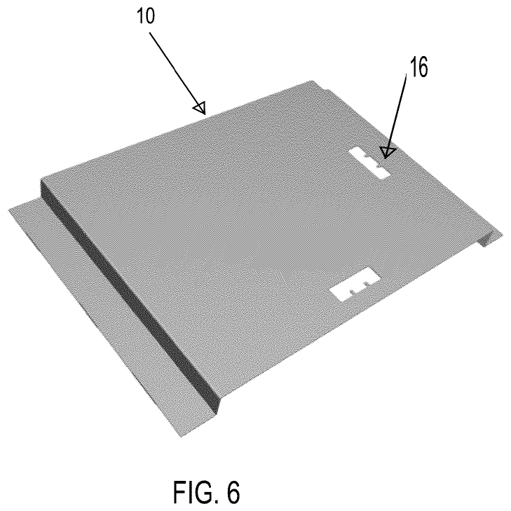

FIG. 6 is a perspective view of the hanging box according to an illustrative implementation. In this image, there is a flat metal edge that attaches to the wall, and may have bumpers (not shown).

FIG. 7 is a view of an aluminum hanging box 10 showing an adhesive 15 for receiving a displayable item. Two openings are shown that may receive the teeth. While this particular implementation shows an adhesive 15, it is to be understood that other attachment constructions may be used, such as fasteners (e.g. Velcro® (hook and loop)) or welding.

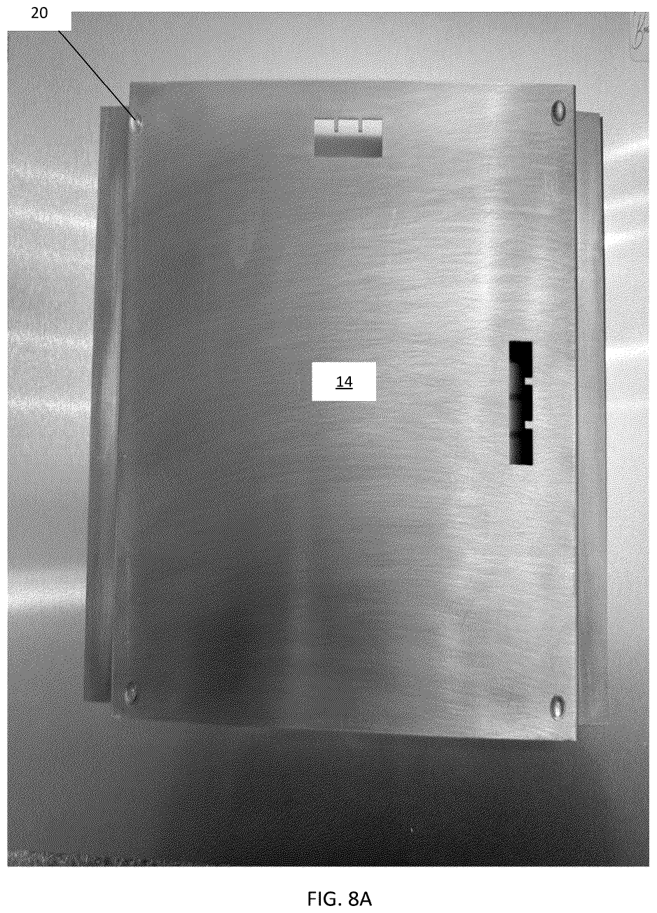

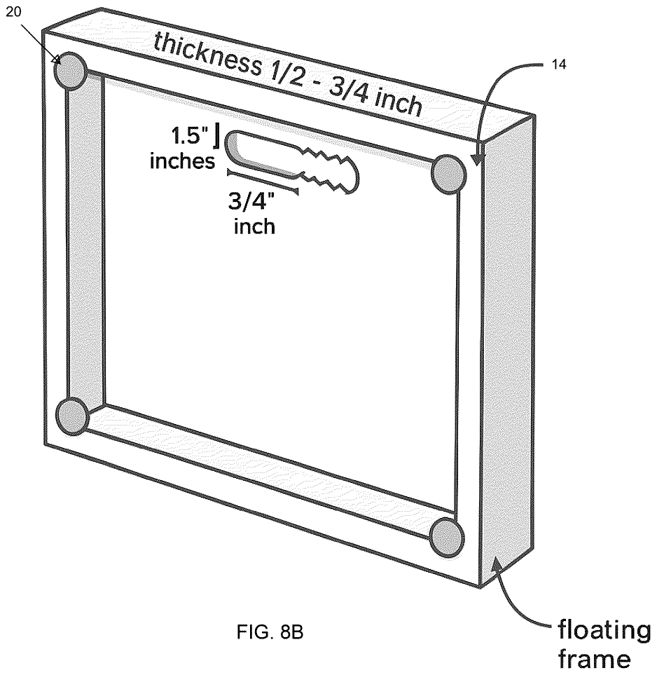

FIG. 8A is a rear view of an aluminum hanging box 10 showing the bumpers and a floating frame, according to an illustrative implementation. The rear 14 of the aluminum hanging box includes bumpers 20, and openings for teeth. The bumpers 20 prevent the wall from being scratched or otherwise damaged when the aluminum hanging box 10 is hung on a wall.

FIG. 8B is a rear view of another implementation of the aluminum hanging box showing the bumpers and the floating frame. It can be seen that the rear side includes bumpers 20 and the rear side 14 of the box. The opening into which the teeth are installed is also shown. It is to be understood that the dimensions shown are merely for illustrative purposes.

While several illustrative embodiments of the disclosure have been shown and described, numerous variations and alternative embodiments will occur to those skilled in the art. Such variations and alternative embodiments are contemplated, and can be made without departing from the scope of the disclosure as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner, so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing detailed description of exemplary and preferred embodiments is presented for purposes of illustration and disclosure in accordance with the requirements of the law. It is not intended to be exhaustive nor to limit the disclosure to the precise form(s) described, but only to enable others skilled in the art to understand how the disclosure may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the disclosure be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for . . . ” and no method or process step herein is to be construed under those provisions unless the step, or steps, are expressly recited using the phrase “step(s) for . . . .”

What is claimed is:

1. An apparatus for suspending a displayable item on a wall, comprising:
a box configured to receive a rear surface of the displayable item, the box having a thickness of approximately ½ to ¾ of an inch;
an opening formed in the box, the opening being about 1.5 inches wide and ¾ inch high; and
a plurality of spaced teeth disposed within the opening and configured to engage with a hook.

2. The apparatus according to claim 1, further comprising plastic bumpers disposed at corners of the box to contact a surface of the wall.

3. The apparatus according to claim 1, wherein the box is constructed of aluminum.

4. The apparatus according to claim 1, wherein the box is constructed of a plastic.

5. The apparatus of claim 1, wherein the box is rectangular and extends across at least a central portion of the rear surface of the displayable item.

6. The apparatus of claim 1, wherein the teeth are angled to resist upward disengagement from the hook.

7. The apparatus of claim 2, wherein the bumpers are formed of an elastomeric material.

8. The apparatus of claim 3, wherein the aluminum box is anodized for corrosion resistance.

9. The apparatus of claim 3, wherein the displayable item comprises a picture.

10. The apparatus of claim 3, wherein the displayable item comprises a metal picture.

11. The apparatus of claim 9, wherein the bumpers maintain a uniform spacing between the picture and the wall surface.

12. The apparatus according to claim 10, wherein the hook comprises a picture hook.

13. The apparatus of claim 1, wherein the box is configured to have the rear surface of the displayable item affixed thereto by adhesive.

14. The apparatus of claim 1, wherein the box is configured to have the rear surface of the displayable item affixed thereto by fasteners.

15. The apparatus of claim 1, wherein the box is configured to have the rear surface of the displayable item affixed thereto by welding.
